(19) United States
(12) Patent Application Publication
(10) Pub. No.: US 2020/0007633 A1
(43) Pub. Date: Jan. 2, 2020

(54) INTELLIGENT DEVICE ENROLLING METHOD, DEVICE ENROLLING APPARATUS AND INTELLIGENT COMPUTING DEVICE

(71) Applicant: LG ELECTRONICS INC., Seoul (KR)

(72) Inventor: Minsoo KIM, Seoul (KR)

(73) Assignee: LG ELECTRONICS INC., Seoul (KR)

(21) Appl. No.: 16/566,670

(22) Filed: Sep. 10, 2019

(30) Foreign Application Priority Data
Jul. 23, 2019 (KR) 10-2019-0088836

(51) Int. Cl. H04L 29/08; H04W 8/00; H04L 12/28; H04W 84/12; H04W 48/16; H04W 48/14; H04W 4/80

(52) U.S. Cl. CPC H04L 67/16; H04W 8/005; H04L 12/2803; H04L 2012/2841; H04W 48/16; H04W 48/14; H04W 4/80; H04W 84/12

(57) ABSTRACT

Disclosed are an intelligent device enrolling method, a device enrolling apparatus, and an intelligent computing device. The method of intelligently enrolling an AI device on a network acquires identification information related to a network connection manner of the AI device from the AI device and enrolls the AI device on a network, thereby being able to remove trouble that a user has to enrolls a new AI device on a server. At least one of the AI devices, servers, and intelligent computing devices may be associated with an artificial intelligence (AI) module, an unmanned aerial vehicle (UAV) (or drone), a robot, an augmented reality (AR) device, a virtual reality (VR) device, and a device related to a 5G service.

### CROSS-REFERENCE TO RELATED APPLICATION(S)

Pursuant to 35 U.S.C. § 119(a), this application claims the benefit of earlier filing date and right of priority to Korean Patent Application No. 10-2019-0088836, filed on Jul. 23, 2019, the contents of which are hereby incorporated by reference herein in its entirety.

### BACKGROUND OF THE INVENTION

### Field of the invention

The present disclosure relates to an intelligent device enrolling method, a device enrolling apparatus, and an intelligent computing device and, more particularly, an intelligent device enrolling method, a device enrolling apparatus, and an intelligent computing device that serve agency for product enrollment of another intelligent device.

### Related Art

Recently, with the development of a 5G communication technology and IoT services, an IoT technology for controlling AI (Artificial Intelligence) devices to which artificial intelligent is applied and that are connected for communication to each other at home of users has risen.

In particular, AI devices are connected for communication to other AI devices through the 5G network, so it is possible to wirelessly control another AI device using one AI device.

Meanwhile, in order to use an AI device, a user turns on an AI device, connects the AI device to a network, finishes enrolling the product of the AI device on a product enrolling server on the connected network, and then can use the AI device.

This causes trouble that a user has to manually progress a product enrollment process of an AI device every time he/she purchases a product.

### SUMMARY OF THE INVENTION

An object of the present disclosure is to meet the needs and solve the problems.

Further, an object of the present disclosure is to provide an intelligent device enrolling method, a device enrolling apparatus, and an intelligent computing device for intelligently performing product enrollment of another AI device.

An intelligent device enrolling method according to an embodiment is characterized by including: acquiring identification information of an AI device from the AI device; and enrolling the AI device on a network on the basis of the identification information of the AI device, in which the identification information includes information related to a network connection manner of the AI device.

The acquiring of identification information of the AI device may receive through resources of a wireless-LAN shared by the AI device.

The acquiring of identification information of the AI device may acquire the identification information through a beacon frame of the wireless-LAN.

The acquiring of identification information of the AI device may acquire the identification information of the AI device from a field related to a service set ID (SSID) of the beacon frame.

The acquiring of identification information of the AI device may receive from the AI device in a broadcasting manner.

The network connection manner of the AI device may further include information related to a protocol manner for data exchange of the AI device.

The network connection manner of the AI device may include information related to a port or a channel allocated to the AI device.

The identification information of the AI device may further include information related to a support function of the AI device.

The identification information of the AI device may further include information related to product enrollment status of the AI device.

The identification information of the AI device may further include information related to the type of a product of the AI device.

A device enrolling apparatus that intelligently enrolls an AI device on a network according to another embodiment of the present disclosure is characterized by including: a communication unit that acquires identification information of an AI device from the AI device; and a processor that enrolls the AI device on a network through the communication unit on the basis of the identification information of the AI device, in which the identification information includes information related to a network connection manner of the AI device.

The processor may receive the identification information of the AI device through resources of a wireless-LAN shared by the AI device.

The processor may acquire the identification information through a beacon frame of the wireless-LAN.

The processor may acquire the identification information of the AI device from a field related to a service set ID (SSID) of the beacon frame.

The processor may receive the identification information of the AI device through a broadcasting manner from the AI device.

The network connection manner of the AI device may further include information related to a protocol manner for data exchange of the AI device.

The network connection manner of the AI device may include information related to a port or a channel allocated to the AI device.

The identification information of the AI device may further include information related to a support function of the AI device.

The identification information of the AI device may further include information related to product enrollment status of the AI device.

The identification information of the AI device may further include information related to the type of a product of the AI device.

A non-transitory computer-readable recording medium that is a non-transitory computer-readable recording medium storing a computer-executable component configured to be executed in one or more processors of a computing device according to another embodiment of the present disclosure acquires identification information of an AI device from the AI device, and enrolls the AI device on a network on the basis of the identification information of the AI device through the communication unit, in which the identification information includes information related to a network connection manner of the AI device.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 shows a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 illustrates an AI system according to an embodiment of the present disclosure.

FIG. 5 shows a block diagram of a device enrolling apparatus (AI device) that can be applied to one embodiment of the present disclosure.

FIG. 6 shows a product enrolling server 30 according to an embodiment of the present disclosure.

FIG. 7 shows a device enrolling method according to an embodiment of the present disclosure.

FIG. 8 shows a device enrolling method of an AI system according to an embodiment of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G

### A. Example of Block Diagram of UE and 5G Network

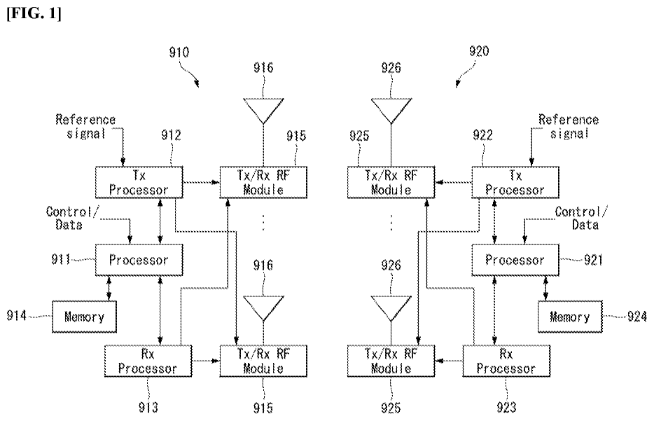

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device(AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

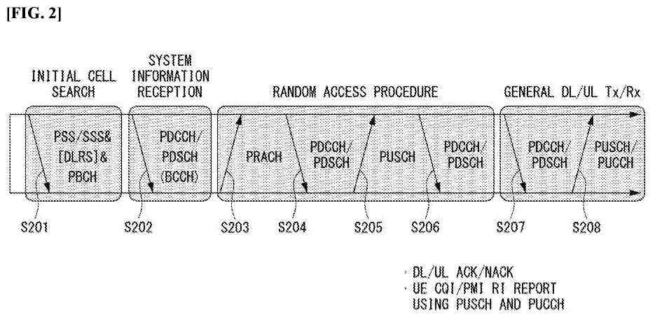

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtaind through an SSS of the cell, and information on the cell ID among 336 cell ID groups is provided/obtaind through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-S SB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

### E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation of AI Processing Using 5G Communication

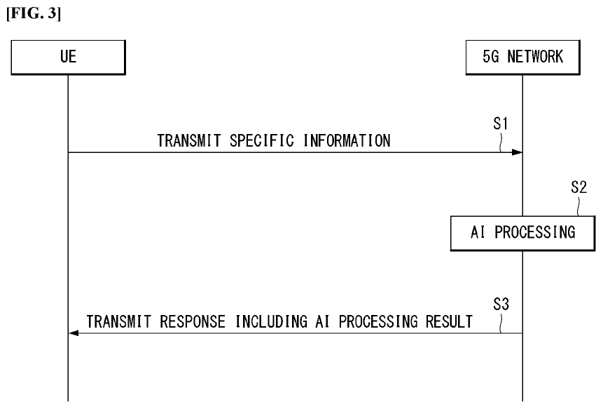

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE(S3).

### G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

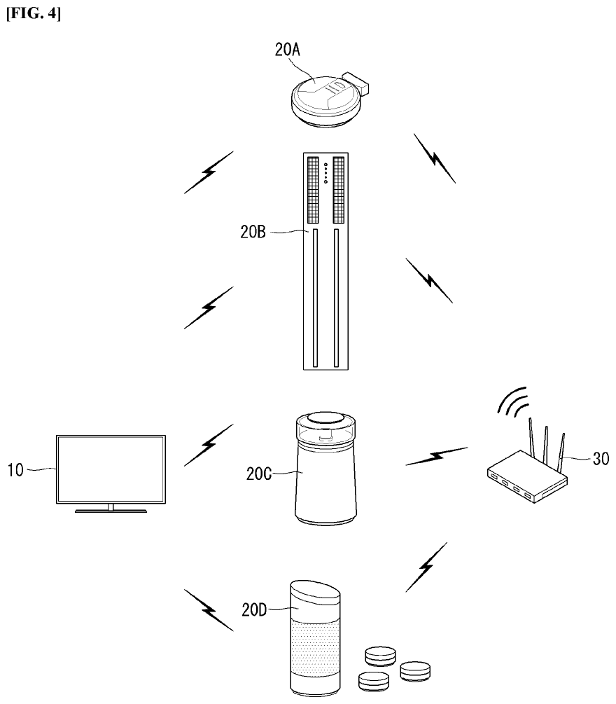

FIG. 4 shows an AI system according to an embodiment of the present disclosure.

As shown in FIG. 4, according to an embodiment of the present disclosure, the AI system may include a plurality of AI devices 10, 20A, 20B, 20C, and 20D and a product enrolling server 30.

The product enrolling server 30 can construct a wire/wireless communication network with the plurality of AI devices 10, 20A, 20B, 20C, and 20D and can transmit/receive data through the wire/wireless communication network. In this case, the product enrolling server 30 can receive a product enrollment request from the plurality of AI devices 10, 20A, 20B, 20C, and 20D and can request information for product enrollment from the plurality of AI devices 10, 20A, 20B, 20C, and 20D on the basis of the product enrollment request. When receiving information for product enrollment from the plurality of AI devices 10, 20A, 20B, 20C, and 20D, the product enrolling server 30 can enroll the products of AI devices that have transmitted information from product enrollment.

The plurality of AI devices 10, 20A, 20B, 20C, and 20D may be connected through the 5G network. For example, the plurality of AI devices 10, 20A, 20B, 20C, and 20D may be connected through an IoT service.

In this case, the plurality of AI devices 10, 20A, 20B, 20C, and 20D may be included in one wireless LAN and may perform Wi-Fi communication among them.

In FIG. 4, a smart TV 10 of the AI devices may be defined in a non-enrolled AI device, and a robot cleaner 20A, a smart air conditioner 20B, an air purifier 20C, and an artificial intelligence speaker 20D may be defined as enrolled AI devices.

In this case, one of the enrolled devices may operate as an AI hub. For example, when the AI hub is the artificial intelligence speaker 20D, the artificial intelligence speaker 20D can control operation of a plurality of AI devices 10, 20A, 20B, 20C, and 20D.

In this case, the enrolled devices or the AI hub can function as a device enrolling apparatus 20 according to an embodiment of the present disclosure. That is, the enrolled devices or the AI hub can perform agency for product enrollment of the smart TV 10 that is a non-enrolled device and the details will be described later.

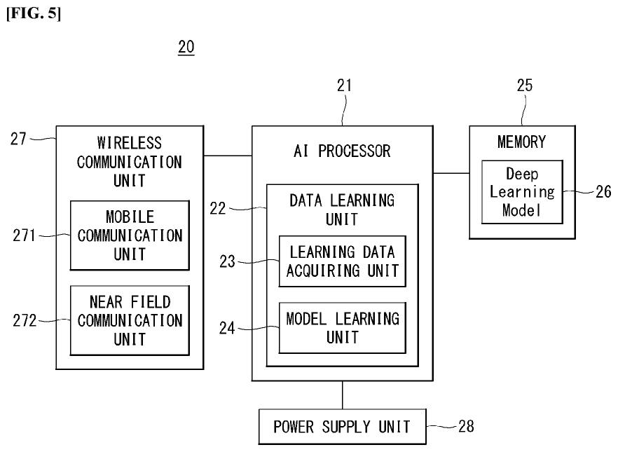

FIG. 5 is a block diagram of a device enrolling apparatus (AI device) that can be applied to embodiments of the present disclosure.

The device enrolling apparatus 20 may include an electronic device including an AI module being able to perform AI processing or a server including the AI module. Further, the device enrolling apparatus 20 may be included at least a part of the device enrolling apparatus 20 shown in FIG. 4 and may be provided to perform together at least some of AI processing.

The AI processing may include all operations related to device enrollment of the device enrolling apparatus 20 shown in FIG. 5.

For example, the AI processing may mean acquiring identification information of the non-enrolled AI device 10 from the AI device 10 through a communication unit 27. In this case, the AI processor 21 can acquire identification information of the AI device 10 that is broadcasted through a Wi-Fi band from the non-enrolled AI device 10 by controlling the communication unit 27. The identification information of the AI device may be included in a beacon frame and transmitted to the device enrolling apparatus 20.

As another example, the AI processing may mean a process of acquiring a network connection manner of the non-enrolled AI device 10 from the identification information of the non-enrolled AI device 10. In this case, the network connection manner may mean a data exchange manner.

The device enrolling apparatus 20 can create information for product enrollment by analyzing identification information of the non-enrolled AI device 10 transmitted with the beacon frame. The AI processing may be information for product enrollment acquired from the identification information of the non-enrolled AI device 10.

The device enrolling apparatus 20 may include an AI processor 21, a memory 25, a communication unit 27, and/or a power supply unit 28.

The device enrolling apparatus 20, which is a computing device being able to learn a neural network, may be implemented as various electronic devices such as a server, a desktop PC, a notebook PC, and a tablet PC.

The AI processor 21 may learn a neural network using a program stored in the memory 25. In particular, the AI processor 21 may analyze the voice data and learn a neural network for authenticating the user who spoke the voice. In addition, the AI processor 21 may analyze the voice data and learn a neural network for recognizing a probability (probability of being authenticated) that the user who spoke the voice is a registered user.

The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, voice output, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present disclosure.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by obtaining learning data to be used for learning and by applying the obtaind learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data obtaining unit 23 and a model learning unit 24.

The learning data acquisition unit 23 may obtain training data for a neural network model for classifying and recognizing data. For example, the learning data acquisition unit 23 may obtain microphone detection signal to be input to the neural network model and/or a feature value, extracted from the message, as the training data.

The model learning unit 24 can perform learning such that a neural network model has a determination reference about how to classify predetermined data, using the obtaind learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor may pre-process an obtained operating state so that the obtained operating state may be used for training for recognizing estimated noise information. For example, the learning data preprocessor may process an obtained operating state in a preset format so that the model training unit 24 may use obtained training data for training for recognizing estimated noise information.

Furthermore, the training data selection unit may select data for training among training data obtained by the learning data acquisition unit 23 or training data pre-processed by the preprocessor. The selected training data may be provided to the model training unit 24. For example, the training data selection unit may select only data for a syllable, included in a specific region, as training data by detecting the specific region in the feature values of an operating state obtained by the voice enable device selecting apparatus 10.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 may include one or more modules enabling wireless communication between the AI devices 10, 20A, 20B, 20C, and 20D and a wireless communication system, between the AI devices 10, 20A, 20B, 20C, and 20D and another AI device, or between the AI devices 10, 20A, 20B, 20C, and 20D and an external server. Further, the communication unit 27 may include one or more modules connecting the AI devices 10, 20A, 20B, 20C, and 20D to one or more networks.

The communication unit 27 may include a mobile communication unit 271 and a near-field communication unit 272 capable of transmitting and receiving data with an external AI device or other external device (eg, an external server or a cloud).

The mobile communication unit 271 may transmits and receives a radio signal with at least one of a base station, an external terminal, and a server on a mobile communication network configured according to technical standards or communication schemes (eg, GSM(Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced)). The wireless signal may include various types of data according to transmission and reception of a voice call signal, a video call call signal, or a text/multimedia message.

The near-field communication unit 272 is for short range communication, and may support short range communication using at least one of the technologies (e.g., Bluetooth™ RFID (Radio Frequency Identification), Infrared Data Association; IrDA, UWB (Ultra Wideband), ZigBee, NFC (Near Field Communication), Wi-Fi (Wireless-Fidelity), Wi-Fi Direct, Wireless USB (Wireless Universal Serial Bus)). These, the near-field communication unit 272 can support communication between AI devices 10A, 20B, 20C, 20D and wireless communication systems, between AI devices 10, 20A, 20B, 20C, 20D and other AI devices, or between AI devices 10, 20B, 20C, 20C, 20D and other network where AI devices are located by Wireless Area Network. Wireless Area Network can be Wireless Personal Area Networks.

Memory 25 stores data that supports variety of functions of AI devices 10, 20A, 20B, 20C, and 20D. Memory 25 can store data and commands for the operation of a number of applications (application programs or applications) that run on AI devices 10, 20A, 20B, 20C, 20D. At least some of these applications can be downloaded from external servers via wireless communication. In addition, at least some of these applications may exist on AI devices 10, 20A, 20B, 20C, 20D from the time of shipment for basic functions of AI devices (e.g., data reception, transmission functions). On the other hand, the application, stored in memory 25, installed on top of the AI device 10, 20A, 20B, 20C, 20D, may be driven by the processor 21, to perform the operation (or function) of the above AI device 10, 20A, 20B, 20C, 20D.

Memory 25 can also store IP addresses shared by the appropriate AI device 10, 20A, 20B, 20C, 20D. Memory 25 can also store identification (ID) of the corresponding AI device 10, 20A, 20B, 20C, 20D.

The power supply unit 28 receives power from an external power source and an internal power source under the control of the processor 21 to supply power to the components included in the AI devices 10, 20A, 20B, 20C, and 20D. The power supply 28 includes a battery, which may be a built-in battery or a replaceable battery.

Meanwhile, the device enrolling apparatus 20 illustrated in FIG. 5 has been described functionally divided into an AI processor 21, a memory 25, a communication unit 27, a power supply unit 28, and the like. and it may be integrated into a module of and called an AI module.

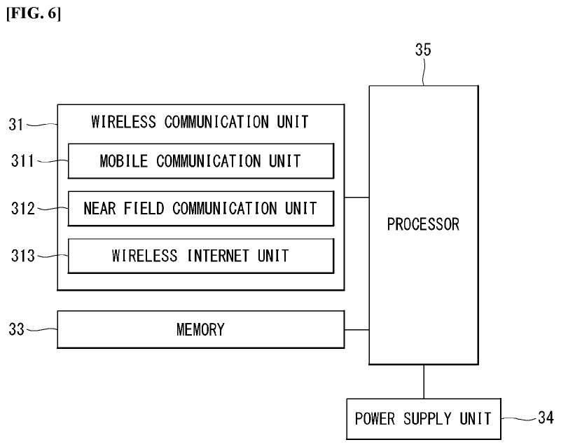

FIG. 6 shows a product enrolling server 30 according to an embodiment of the present disclosure.

As shown in FIG. 6, the product enrolling server 30 may include a wireless communication unit 31, a memory 33, a power supply unit 34, and a processor 35.

The wireless communication unit 31 of the product enrolling server 3, and a mobile communication unit 311 and a near-field communication unit 312 of the wireless communication unit 31 in FIG. 6 respectively can perform the functions of the communication unit 27 of the AI devices 10, 20A, 20B, 20C, and 20D, and the mobile communication unit 271 and the near-field communication unit 272 of the communication unit 27 described above with reference to FIG. 5. Further, a wireless internet unit 313 of the product enrolling server 3 can connect with wireless internet and download at least one service for product enrollment of the non-enrolled AI device 10.

The power supply unit 34 of the product enrolling server 3 of FIG. 6 can perform the function of the power supply unit 28 of the device enrolling apparatus 20 described with reference to FIG. 5.

The memory 33 can store product enrollment information (device IDs and user accountants corresponding to device) created in advance.

The processor 35 can receive a product enrollment request and product identification information from the device enrolling apparatus 20 through the wireless communication unit 31. The processor 35 can store transmitted product identification information in the memory 33 in response to the product enrollment request.

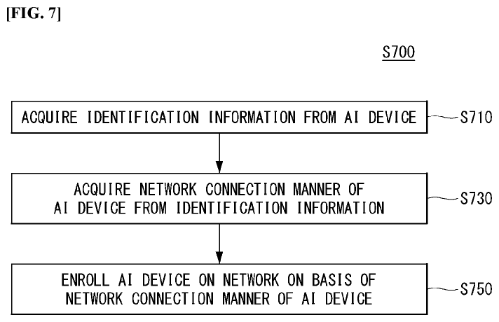

FIG. 7 shows a device enrolling method according to an embodiment of the present disclosure.

As shown in FIG. 7, a device enrolling method (S700) of the device enrolling apparatus 20 according to an embodiment of the present disclosure may include steps S710, S730, and S750 and the detailed description is as follows.

First, the Ai processor 21 of the device enrolling apparatus 20 can acquire identification information of the AI device 10 from the non-enrolled AI device 10 (S710).

As described above, the identification information ID of the AI device 10 can be included in a beacon frame and broadcasted to the AI device 10 through a wireless LAN network.

Next, the AI processor 21 can acquire the network connection manner of the AI device from the transmitted identification information (S730).

In this case, the network connection manner of the AI device may include information related to a data exchange manner of the AI device.

Finally, the AI processor 21 can enroll the AI device on the network (product enrolling server 30) on the basis of the network connection manner of the non-enrolled AI device 10.

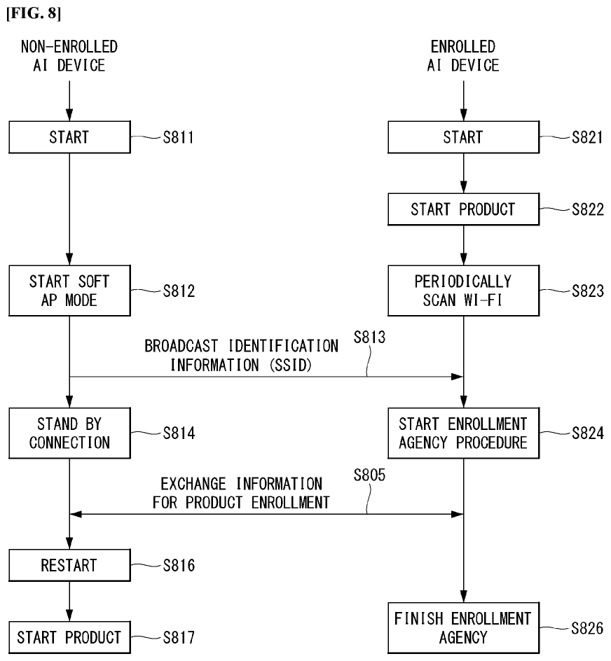

FIG. 8 shows a device enrolling method of an AI system according to an embodiment of the present disclosure.

As shown in FIG. 8, the non-enrolled AI device 10 is started first (S811) and then can start a soft AP mode (S812).

In this case, the non-enrolled device 10 is an en-rolled device that has not been enrolled as a product by a user. The soft AP mode may be a mode for starting a produce enrollment procedure before the product is started.

Next, the non-enrolled AI device 10 can broadcast identification information SSID to surrounding AI devices through a Wi-Fi network (S813).

In this case, the identification information SSID may include a service set ID. That is, the identification information SSID may mean a service set ID for the AI device 10 to receive an IoT service from a network.

In this case, the non-enrolled AI device 10 can load and transmit the identification information SSID in a beacon frame of a broadcasted signal.

The identification information SSID may include information about the profile of the non-enrolled AI device 10. The identification information SSID can be broadcasted to beacon-surrounding devices (including an enrolled AI device) through a source of a Wi-Fi band.

Thereafter, the non-enrolled AI device 10 can stand by connection of another device until another procedure is performed (S814).

Meanwhile, an enrolled AI device that has already been enrolled (device enrolling apparatus 20) can be started (S821), can start a product (S822), and can periodically scan Wi-Fi signals.

When receiving the identification information SSID broadcasted from the non-enrolled AI device 10, the enrolled AI device 20 can start an enrollment agency procedure (S824).

In this case, when the enrolled AI device 20 performs the enrollment agency procedure, the enrolled AI device 20 can perform the enrollment agency procedure using the identification information SSID of the non-enrolled AI device 10 (S824).

For example, the enrolled AI device 20 can acquire the network connection manner (data exchange manner) of the non-enrolled AI device 10 from the identification information SSID and can perform the enrollment agency procedure of the non-enrolled AI device 10 on the basis of the network connection manner of the non-enrolled AI device 10. Further, the enrolled AI device 20 can acquire the product type, the product profile, and the data exchange manner of the non-enrolled AI device 10 by analyzing the identification information SSID of the non-enrolled AI device 10.

Next, the enrolled AI device 20 can request information for production enrollment to the non-enrolled AI device 10 and can receive the information (S805). For example, the enrolled AI device 20 can acquire information for Wi-Fi connection of the non-enrolled AI device 10, an authentication code that is used by the non-enrolled AI device 10 when enrollment of the non-enrolled AI device 10 is finished.

Thereafter, the when the enrollment agency procedure for the non-enrolled AI device 10 by the enrolled AI device 20 is finished (S826), the non-enrolled AI device 10 is restarted (S816) and can start the product.

Meanwhile, an SSID field of the non-enrolled AI device 10 that the device enrolling apparatus 20 receives is described in detail.

According to an embodiment of the present disclosure, the non-enrolled AI device 10 can configure SSID of 32 bytes.

The following information may be included in the SSID.

1) Kind information of product (Type)
Kind of non-enrolled AI device 10

2) Support function information of product (Profile)
AI support availability
Voice recognition support availability
Internet support availability
All type of information that can be expressed other than the above

3) Information related to method for information exchange between AI devices (Communication)

4) Status code of current product (Status)

In this case, the SSID field in the Wi-Fi beacon frame may be configured by a string of 33 bytes. Further, the SSID field in the Wi-Fi beacon frame may be configured by ASCII/DIGITS, etc.

In detail, the string of 32 bytes may be composed of the following information.

1) Keyword showing non-enrolled device of manufacturer (Keyword)
Ex: LGEHA (5 bytes)

2) Product profile information
Product type (Type) (3 bytes) (Ex: produce type codes such as refrigerator 101, laundry machine 102, TV 201, oven 301, ThinQHub 401)
Product support function level (3 bytes) (Ex: showing that it is possible to support Full Features such as AI support)

As described above, the non-enrolled AI device 10 can configure the product support function level by 3 bytes of the 32 bytes of the SSID field included in the Wi-Fi beacon frame and can express 3 bytes in a bit string of 24 bits.

When a product support function level is expressed in 24 bits, a supportable function can be expressed for each bit as follows.
24 bit: AI support availability
23 bit: Machine learning support availability
22 bit: Voice recognition support availability

3) Protocol type (1 bytes) for data exchange
Socket (TCP: 1, UDP: 2)
Bluetooth (3)
ZIGBEE (4), preferred communication manner declared

4) Port information or channel information for data exchange (5 bytes)
Port (antenna port) or channel (physical channel) allocated for data exchange through protocol declared in 3)

5) Status code (2 bytes)
Code expressing current status

Ex) 01: requiring product enrollment procedure

Ex) 99: showing other error, etc.

Embodiment 1: An intelligent device enrolling method according to an embodiment is characterized by including: acquiring identification information of an AI device from the AI device; and enrolling the AI device on a network on the basis of the identification information of the AI device, in which the identification information includes information related to a network connection manner of the AI device.

Embodiment 2: In the embodiment 1, the acquiring of identification information of the AI device may be characterized by receiving through resources of a wireless-LAN shared by the AI device.

Embodiment 3: In the embodiment 2, the acquiring of identification information of the AI device may be characterized by acquiring the identification information through a beacon frame of the wireless-LAN.

Embodiment 4: In the embodiment 3, the acquiring of identification information of the AI device may be characterized by acquiring the identification information of the AI device from a field related to a service set ID (SSID) of the beacon frame.

Embodiment 5: In the embodiment 4, the acquiring of identification information of the AI device may be characterized by receiving through a broadcasting manner from the AI device.

Embodiment 6: In the embodiment 1, the network connection manner of the AI device may be characterized by further including information related to a protocol manner for data exchange of the AI device.

Embodiment 7: In the embodiment 6, the network connection manner of the AI device may be characterized by including information related to a port or a channel allocated to the AI device.

Embodiment 8: In the embodiment 1, the identification information of the AI device may be characterized by further including information related to a support function of the AI device.

Embodiment 9: In the embodiment 1, the identification information of the AI device may be characterized by further including information related to a product enrollment status of the AI device.

Embodiment 10: In the embodiment 1, the identification information of the AI device may be characterized by further including information related to the type of a product of the AI device.

Embodiment 11: A device enrolling apparatus that intelligently enrolls an AI device on a network according to another embodiment of the present disclosure is characterized by including: a communication unit that acquires identification information of an AI device from the AI device; and a processor that enrolls the AI device on a network through the communication unit on the basis of the identification information of the AI device, in which the identification information includes information related to a network connection manner of the AI device.

Embodiment 12: In the embodiment 11, the processor may be characterized by receiving the identification information of the AI device through resources of a wireless-LAN s hared by the AI device.

Embodiment 13: In the embodiment 12, the processor may be characterized by acquiring the identification information through a beacon frame of the wireless-LAN.

Embodiment 14: In the embodiment 13, the processor may be characterized by acquiring the identification information of the AI device from a field related to a service set ID (SSID) of the beacon frame.

Embodiment 15: In the embodiment 14, the processor may be characterized by receiving the identification information of the AI device through a broadcasting manner from the AI device.

Embodiment 16: In the embodiment 11, the network connection manner of the AI device may be characterized by further including information related to a protocol manner for data exchange of the AI device.

Embodiment 17: In the embodiment 16, the network connection manner of the AI device may be characterized by including information related to a port or a channel allocated to the AI device.

Embodiment 18: In the embodiment 11, the identification information of the AI device may be characterized by further including information related to a support function of the AI device.

Embodiment 19: In the embodiment 11, the identification information of the AI device may be characterized by further including information related to a product enrollment status of the AI device.

Embodiment 20: In the embodiment 11, the identification information of the AI device may be characterized by further including information related to the type of a product of the AI device.

Embodiment 21: A non-transitory computer-readable recording medium that is a non-transitory computer-readable recording medium storing a computer-executable component configured to be executed in one or more processors of a computing device, is characterized by acquiring identification information of an AI device from the AI device, and enrolling the AI device on a network on the basis of the identification information of the AI device through the communication unit, in which the identification information includes information related to a network connection manner of the AI device.

The present disclosure can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

The effects of the intelligent device enrolling method, device enrolling apparatus, and intelligent computing device according to an embodiment of the present disclosure are as follows.

When enrolling a new purchased AI device on a product enrollment server, an existing AI device enrolled already as a product on a product enrollment server performs agency for enrollment of the new AI device, thereby being able to remove trouble that a user has to enroll the new AI device on the server.

The effects obtainable in the present disclosure are not limited to the above-mentioned effects, and other effects not mentioned will be clearly understood by those skilled in the art from the following description.

What is claimed is:

1. A method of intelligently enrolling an AI device on a network, the method comprising:
acquiring identification information of the AI device from the AI device; and
enrolling the AI device on the network on the basis of the identification information of the AI device,
wherein the identification information includes information related to a network connection manner of the AI device.

2. The method of claim 1, wherein the acquiring of identification information of the AI device receives through resources of a wireless-LAN shared by the AI device.

3. The method of claim 2, wherein the acquiring of identification information of the AI device acquires the identification information through a beacon frame of the wireless-LAN.

4. The method of claim 3, wherein the acquiring of identification information of the AI device acquires the identification information of the AI device from a field related to a service set ID (SSID) of the beacon frame.

5. The method of claim 4, wherein
the acquiring of identification information of the AI device receives from the AI device in a broadcasting manner.

6. The method of claim 1, wherein the network connection manner of the AI device further includes information related to a protocol manner for data exchange of the AI device.

7. The method of claim 6, wherein the network connection manner of the AI device includes information related to a port or a channel allocated to the AI device.

8. The method of claim 1, wherein the identification information of the AI device further includes information related to a support function of the AI device.

9. The method of claim 1, wherein the identification information of the AI device further includes information related to a product enrollment status of the AI device.

10. The method of claim 1, wherein the identification information of the AI device further includes information related to the type of a product of the AI device.

11. A device enrolling apparatus that intelligently enrolls an AI device on a network, the device enrolling apparatus comprising:
a RF module that acquires identification information of an AI device from the AI device; and
a processor that enrolls the AI device on a network through the RF module on the basis of the identification information of the AI device,
wherein the identification information includes information related to a network connection manner of the AI device.

12. The device enrolling apparatus of claim 11, wherein the processor receives the identification information of the AI device through resources of a wireless-LAN shared by the AI device.

13. The device enrolling apparatus of claim 12, wherein the processor acquires the identification information through a beacon frame of the wireless-LAN.

14. The device enrolling apparatus of claim 13, wherein the processor may acquire the identification information of the AI device from a field related to a service set ID (SSID) of the beacon frame.

15. The device enrolling apparatus of claim 14, wherein the processor receives the identification information of the AI device through a broadcasting manner from the AI device.

16. The device enrolling apparatus of claim 11, wherein the network connection manner of the AI device further includes information related to a protocol manner for data exchange of the AI device.

17. The device enrolling apparatus of claim 16, wherein the network connection manner of the AI device includes information related to a port or a channel allocated to the AI device.

18. The device enrolling apparatus of claim 11, wherein the identification information of the AI device further includes information related to a support function of the AI device.

19. The device enrolling apparatus of claim 11, wherein the identification information of the AI device further includes information related to a product enrollment status of the AI device.

20. The device enrolling apparatus of claim 11, wherein the identification information of the AI device further includes information related to the type of a product of the AI device.
